(19) United States
(12) Patent Application Publication
(10) Pub. No.: US 2017/0132537 A1
(43) Pub. Date: May 11, 2017

(54) A COMPUTER IMPLEMENTED METHOD OF DERIVING PERFORMANCE FROM A LOCAL MODEL

(71) Applicant: Imperial Innovations Limited

(72) Inventor: Erik Chavez, London (GB)

(21) Appl. No.: 15/300,162

(22) PCT Filed: Mar. 26, 2015
(86) PCT No.: PCT/GB2015/050911

§ 371 Date: Sep. 28, 2016

(30) Foreign Application Priority Data
Mar. 31, 2014 (GB) 1405788.9

(51) Int. Cl. G06Q 10/04; G06Q 30/02; G06Q 10/06

(52) U.S. Cl. CPC G06Q 10/04; G06Q 10/0635; G06Q 30/0205

(57) ABSTRACT

A computer implemented method of deriving performance from a local model having a plurality of model inputs, comprising identifying a key model input affecting model output for a predetermined model environment, obtaining a prediction of a future key model input value and inputting the future key model input value to the local model to derive predicted performance

The invention relates to a computer implemented method of deriving performance from a local model.

There is a requirement for improved modelling in areas having complex or numerous parameters. For example in the area of weather and crop yield prediction, improved modelling is required. One known approach is described in U.S. Pat. No. 7,702,597 in which historical data is used to derive prediction equations using piecewise linear regression methods to optimise equation co-efficients. However there is a need to provide improved modelling in particular in view of changes to underlying parameters for example caused by climate change, as well as the potential impacts of low probability, high impact events such as extreme climatic events.

The statistics of weather, including of its extreme events, are changing slowly in time. An increasing body of scientific evidence, derived from both observations and model simulations, indicates that the climate system never was nor is it likely to ever be statistically stationary. However the statistical characterization of weather extremes is fraught with various difficulties. These stem from the potentially large effects caused by lack of stationarity and the existence of complex non-linear processes or threshold effects. The assessment of the existence, as well as the prediction, of such stochastic effects on weather extremes requires the identification of their driving factors. Thus, changes in seasonal to annual weather variability of importance for food production derive from modifications of the statistics of inter-annual to inter-decadal climate processes. For instance, changes in the annual rainfall season onset in the tropics and sub-tropics plays a significant role in shaping regional outputs for rainfed crops and derives from the modification of different large scale climate processes driving regional to global climate variability.

The interaction of global climate forcing, derived from increased emissions of green-house gases, with regional climate forcings, resulting from tropospheric pollution and natural climate variability, amplify the uncertainty of projections of local weather variability in climate models. In particular, the prediction of local seasonal and annual precipitation variability such as rainfall season onset dates is uncertain and represents a persistent barrier to robust forecasting of the impacts of weather variability on food supply.

The invention is set out in the claims. By identifying key model inputs, such as weather indices, at the local model level, predictions can be aggregated over a heterogeneous region. In addition, the model enables future projections of model inputs under different model environments, and derived predicted performance based on the future projections of model input parameters.

Embodiments of the invention will now be described by way of example with reference to the drawings of which:

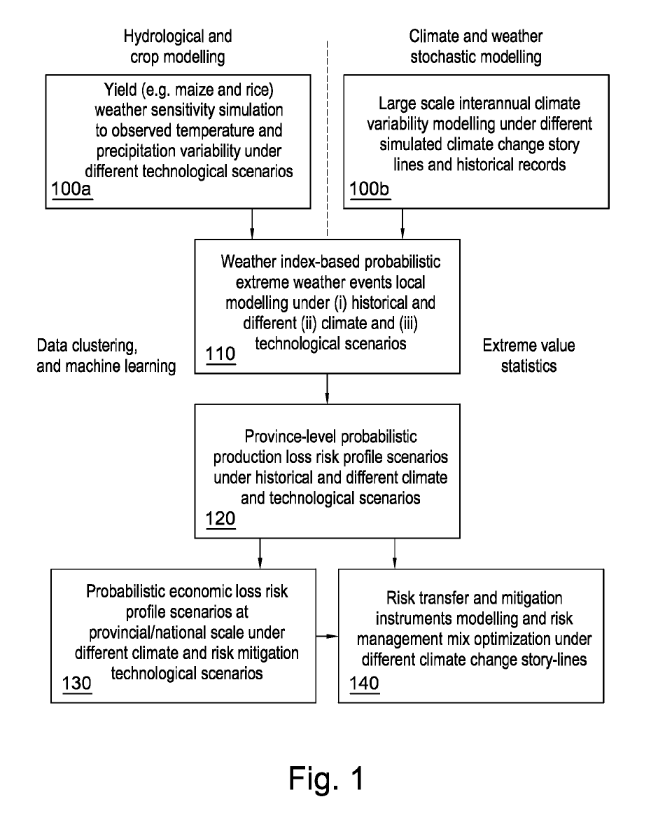

FIG. 1 shows a flow diagram illustrating the steps of a method according to the present disclosure, more specifically, a flow-diagram illustration of steps for deriving crop yield and economic risk profiles;

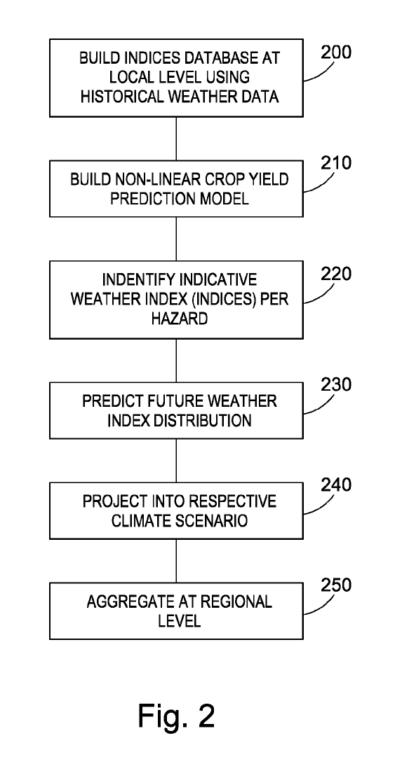

FIG. 2 shows a flow diagram illustrating the steps of a method according to the present disclosure;

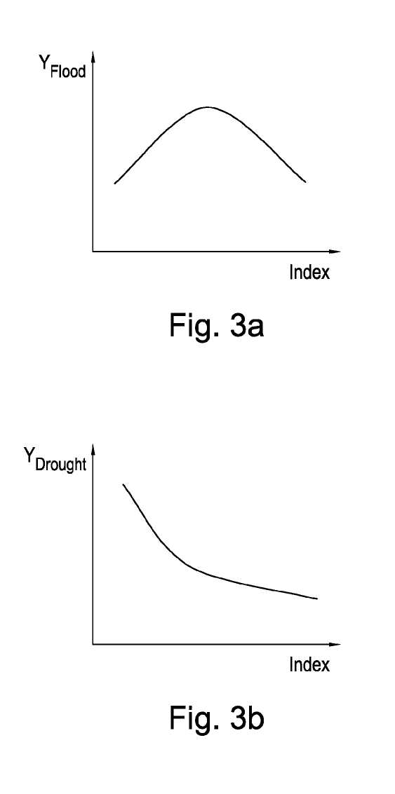

FIG. 3 shows a crop yield model in the case of two scenarios;

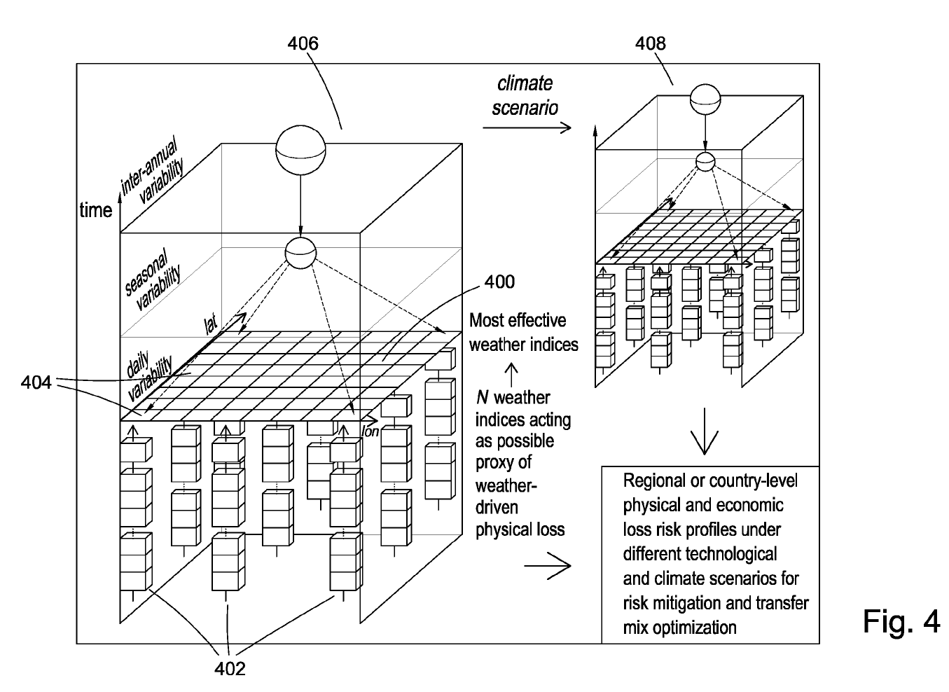

FIG. 4 shows an illustration of the “weather-within-climate” and index-based local-to-regional weather risk modelling framework;

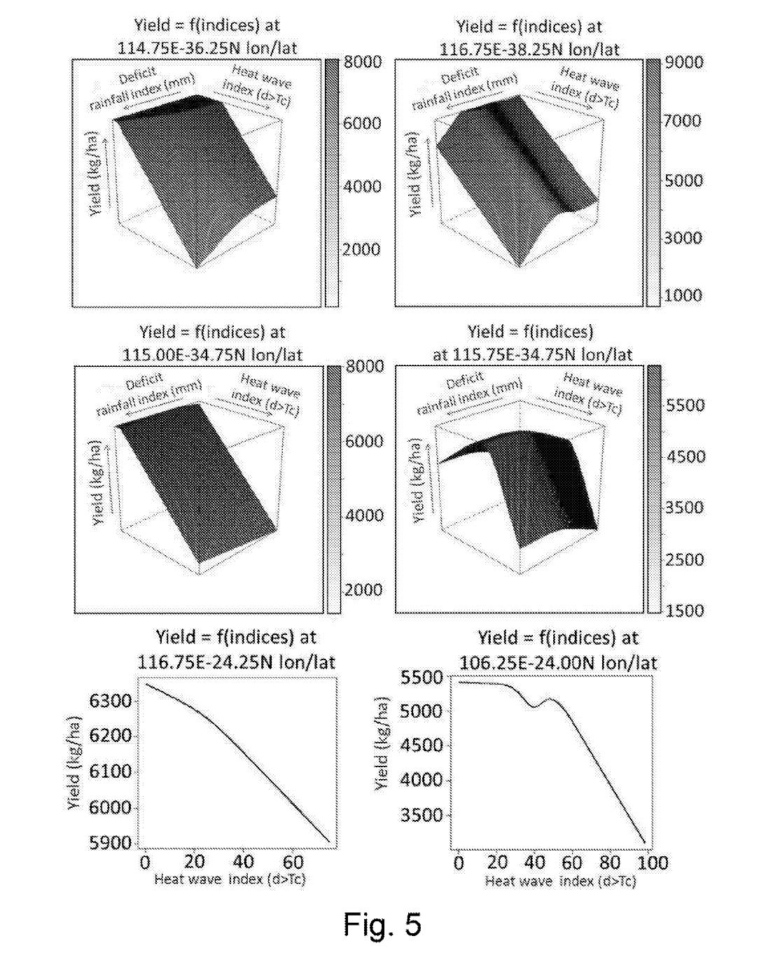

FIG. 5 shows a several types of maize yield responses to heat wave and precipitation indices;

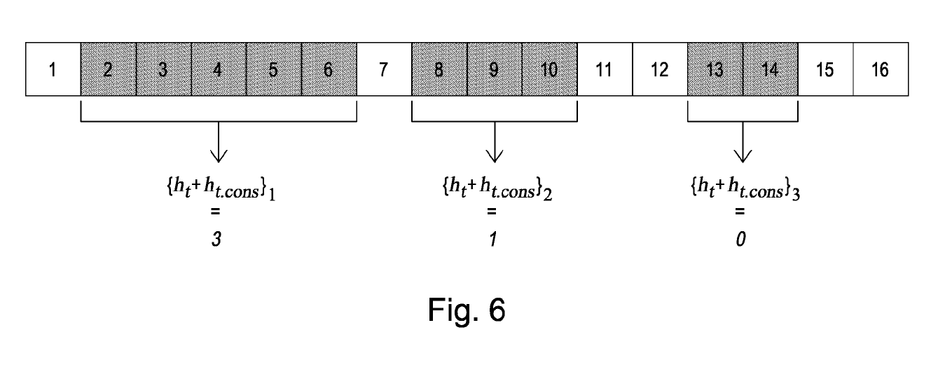

FIG. 6 shows an illustration of a heat wave calculation;

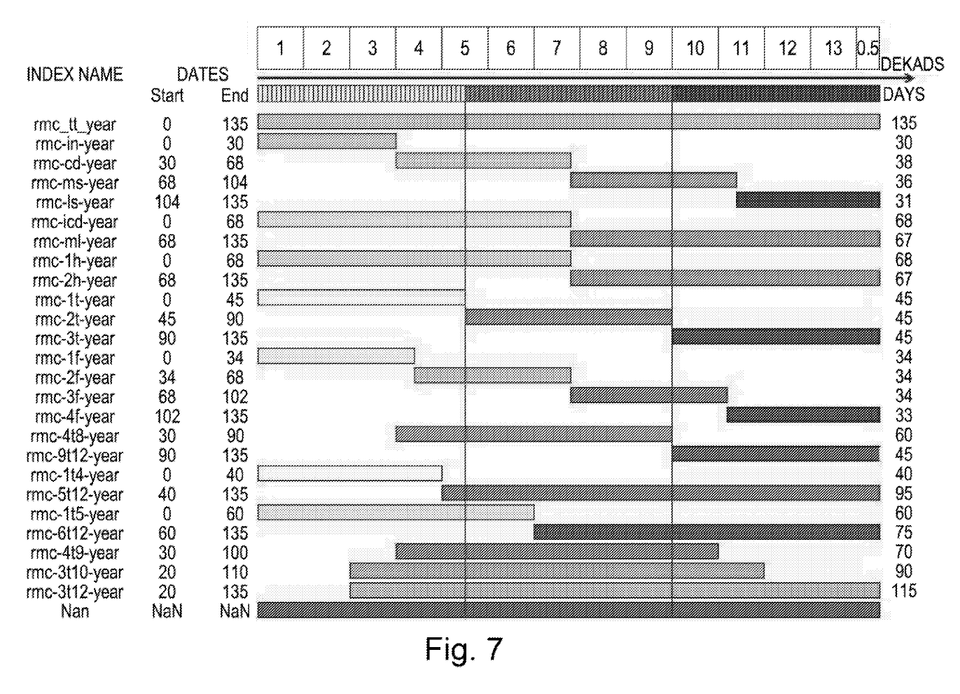

FIG. 7 shows an illustration of cumulative weather indices sample building;

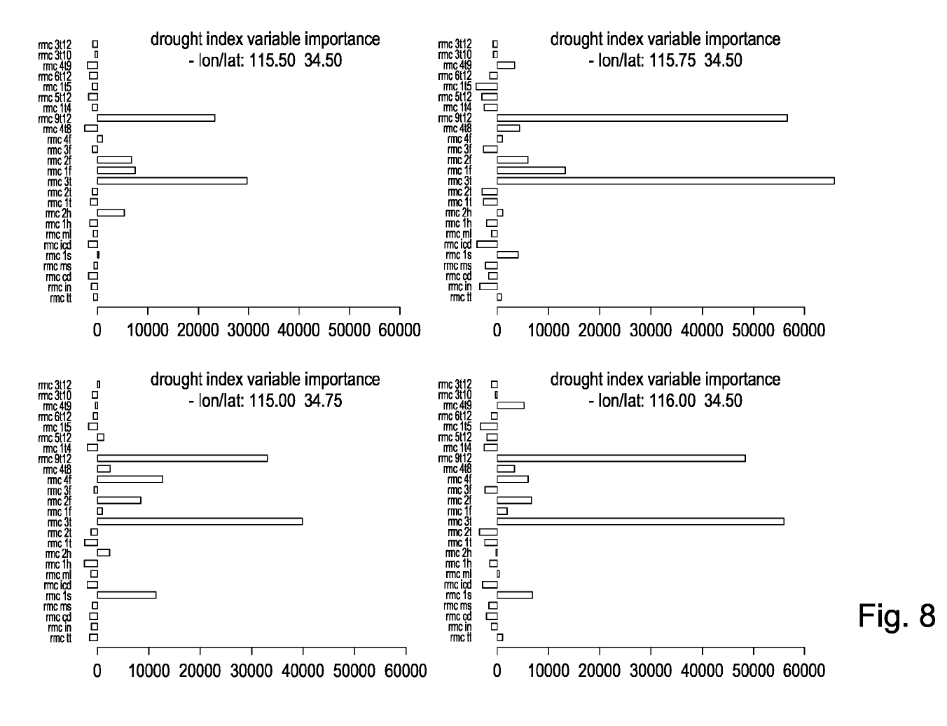

FIG. 8 shows an illustration of the Random Forest-based variable permutation importance index in four contiguous grid boxes in Shandong province using maize yield as response variable;

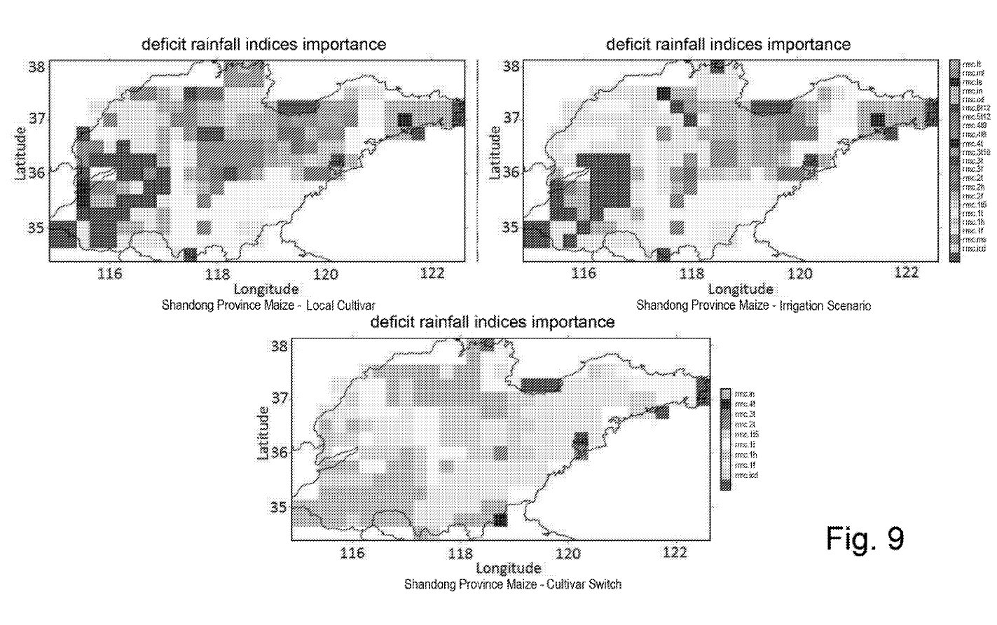

FIG. 9 shows selection results for maize deficit precipitation indices under several different scenarios;

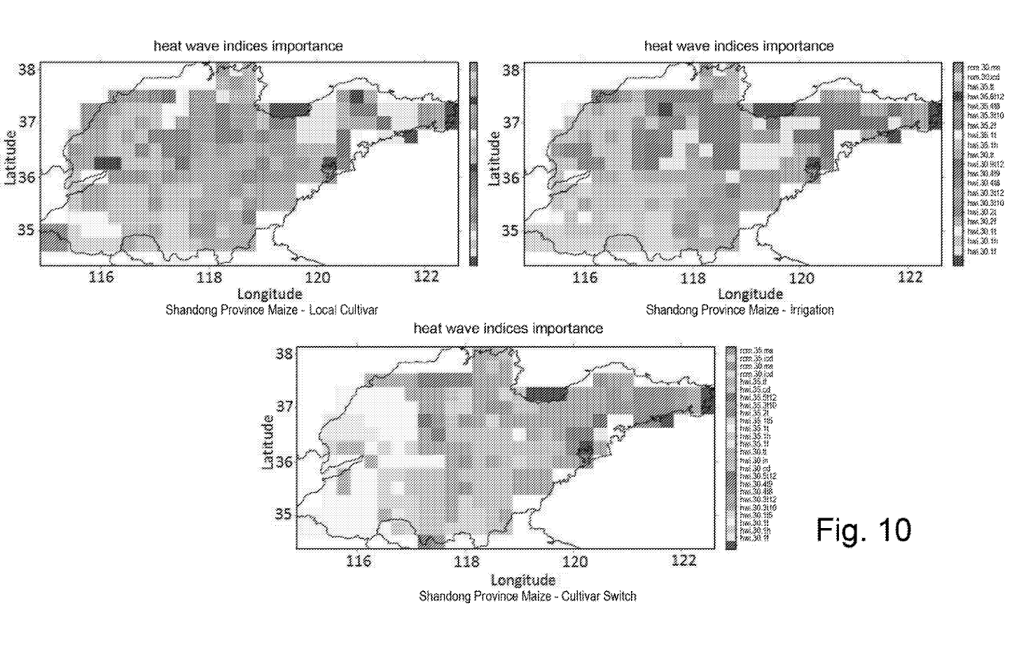

FIG. 10 shows maize heat wave indices selection results under several different scenarios;

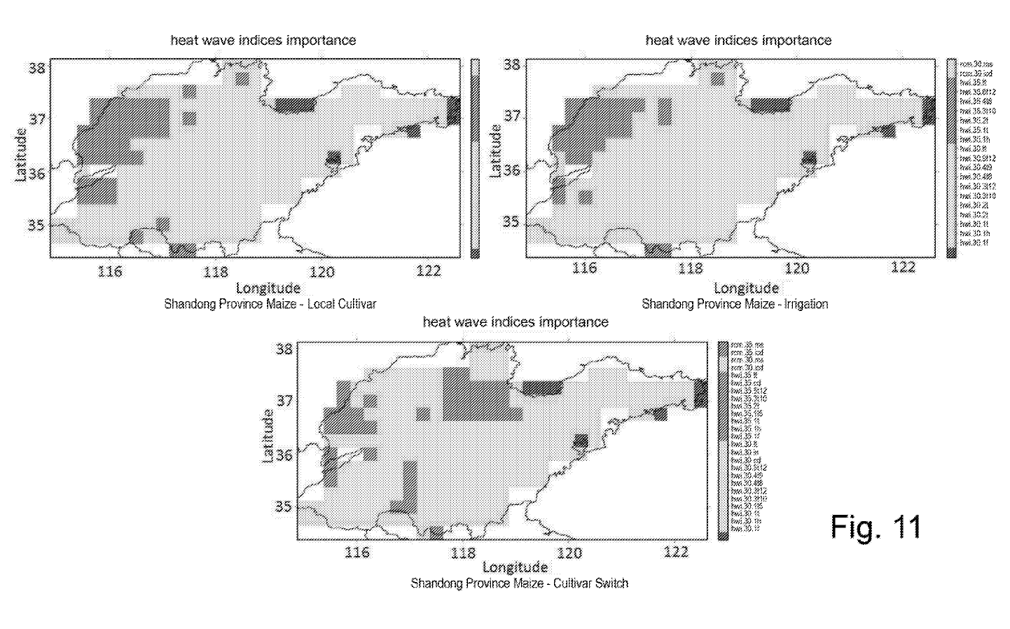

FIG. 11 shows an illustration of critical temperature thresholds under several different scenarios;

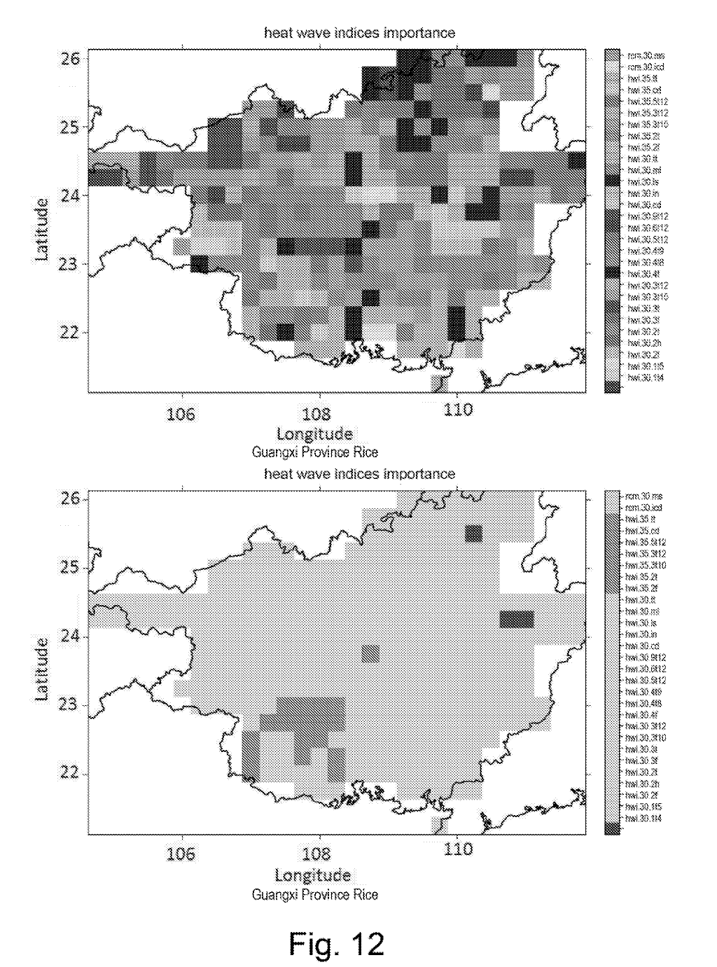

FIG. 12 illustrates the result of different heat wave index selection results;

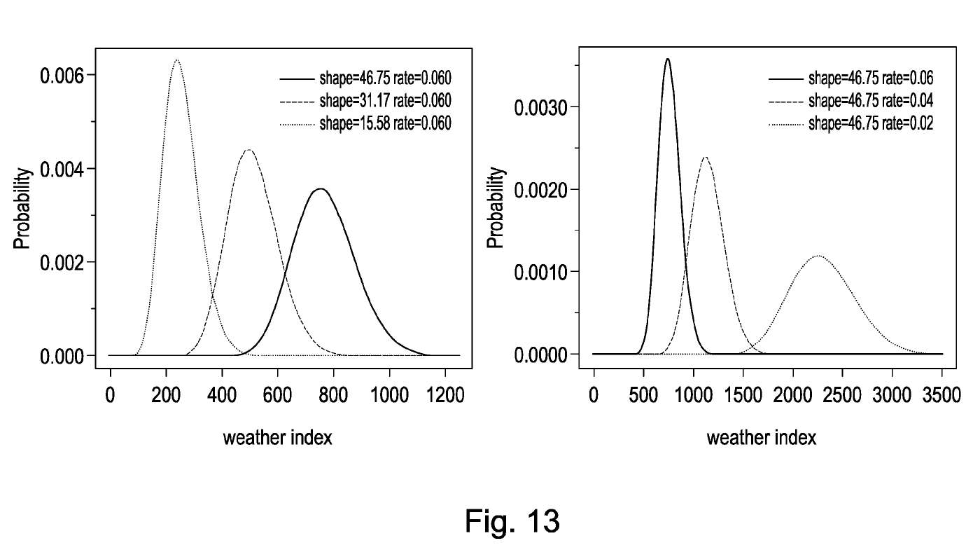

FIG. 13 illustrates Gamma probability density functions of index under different parameter conditions;

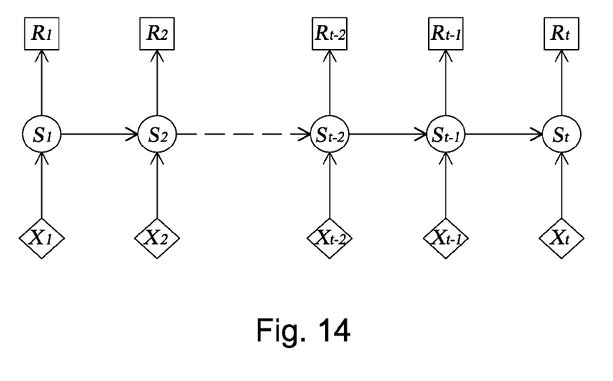

FIG. 14 shows an illustration of regional weather regime and large scale atmospheric modelling using conditional probabilistic NHMM modelling of indices Probability Distribution Functions (PDFs);

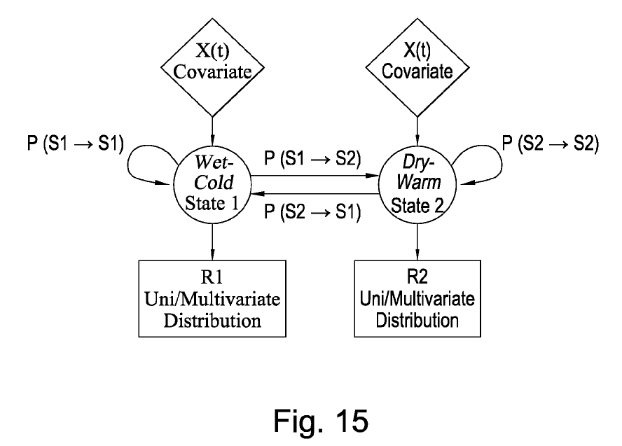

FIG. 15 shows an illustration of the steps of a Nonhomogenous Hidden Markov Model (NHMM) in accordance with a method of the present disclosure;

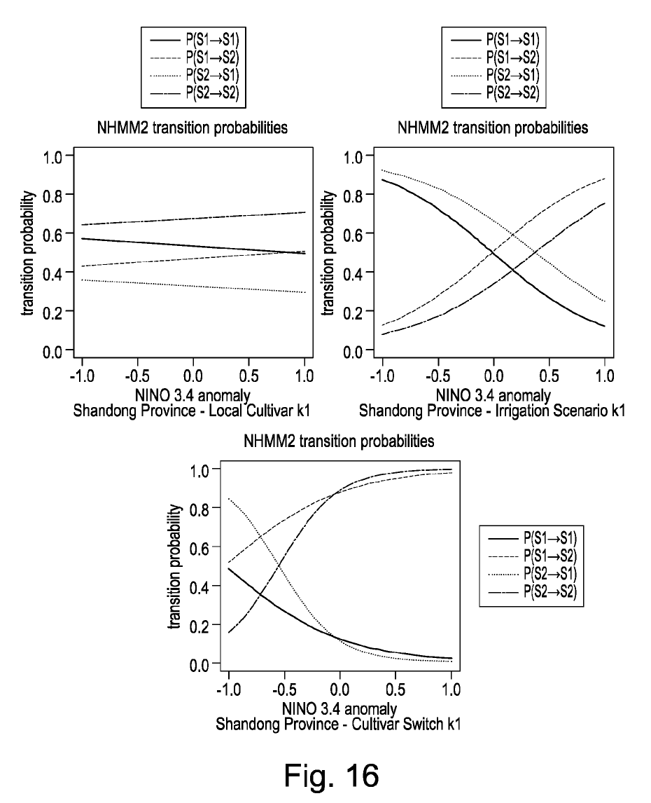

FIG. 16 shows an illustration of the univariate “Viterbi weighting” computation; and

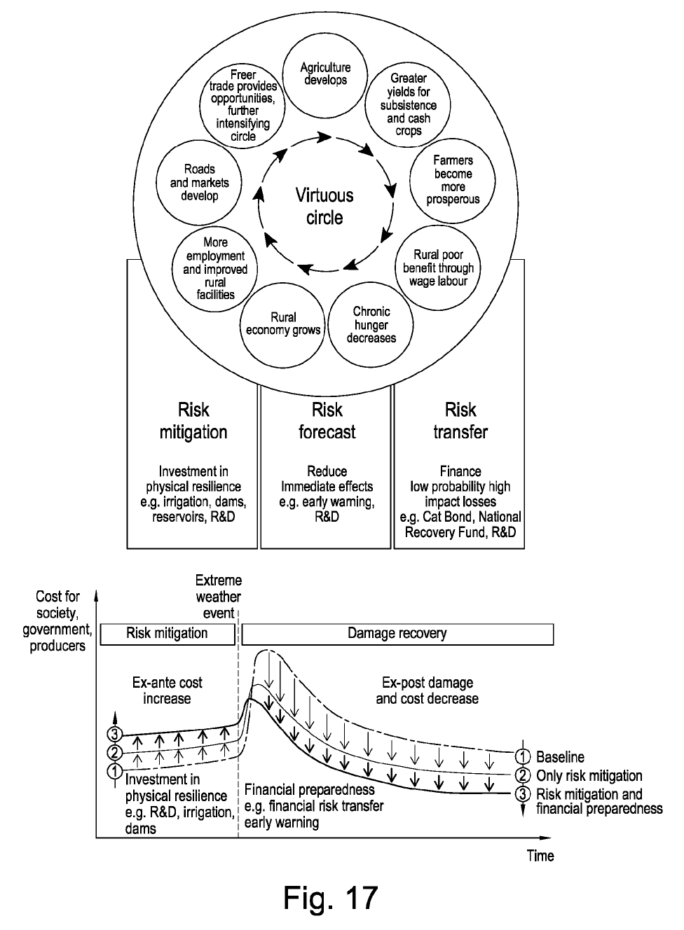

FIG. 17 shows an illustration of the three-pillar based risk management enabling environment in accordance with a method of the present disclosure.

In overview, a model representing local performance is used for example to explain yield variability as the function of weather variation. A key weather index amongst a plurality of indices is identified which can act as proxy for weather driven crop yield variability hazards such as deficient rainfall or excess temperature.

Given the strong dependence of crop vulnerability resulting from the interaction of variety-specific growth dynamics with local environmental characteristics and weather variability, the modelling of optimum weather indices is key to robust local-to-regional weather-driven estimation of yield variability. Observed historical weather daily data and soil data are used to generate time series of simulated crop yields using mechanistic crop modelling. Daily precipitation and temperature (maximum and minimum temperature) data are used to build pixel-level databases of precipitation and temperature variability indices.

Each index captures exposure to deficit precipitation or excess temperature during different overlapping and non-overlapping periods of the crop growth.

Future possible weather indices can then be estimated by projecting robust weather (indices) distributions into future climate scenarios by using simulated large scale climate variables (e.g. sea surface temperature) modelled more accurately than variables such as local precipitation or temperature given the current limited spatial resolution of Global Climate Models (GCM) constrained by available computing power.

The vulnerability of crops to weather variability changes dynamically over their growing period. In addition, the length of growing period and of different growing stages is constrained by local weather variability and environmental conditions. In addition to more noticeable and extreme events, the incidence and impacts of both slight changes in planting seasons and duration of weather patterns will negatively impact agriculture. The machine learning-based index selection methodology that is applied here reveals the existence of strong local spatial heterogeneity in the optimum weather indices that capture weather-driven yield variability at grid level. Hence an accurate regional level projection is derived by aggregating the grid-level outcomes.

The results obtained demonstrate that important variations of province-level risk profiles depend on the regional features of weather and climate variability and technological scenarios, in some regions the effect of low frequency climate state changes is masked by the important high frequency weather variability. In contrast, other regions are characterized by a strong dependence of weather variability driven risk on the variability of low frequency climate states. Under a given state, the risk profiles exhibit minimum variation for varying return periods of weather events, whereas drastic loss jumps are observed with global climate affects.

Economic loss probabilistic risk profiles follow aggregate country-level profiles of the physical loss risk, permitting detailed risk projection and prediction.

In overview, there is provided a method that integrates large and small scale information, and is based on both observed and simulated data, such as data concerning weather, climate and economic conditions. More specifically, the method constrains the economic impacts by the local and regional characteristics of weather variability and climate state changes, by the local response of the system considered—for example the crop production sector—and by the scenarios of technological risk mitigation. The method may use machine learning of weather indices as proxies to characterise crop vulnerability to weather variations, such as precipitation and temperature variability. Furthermore, the method may use a “weather-within-climate” stochastic downscaling approach to quantify the interaction of low and high frequency climate variability, and project risk profiles into future climate scenarios. Probabilistic, weather-driven, physical-loss risk profiles may also be used to model supply, shock-driven, direct and indirect economic losses in a particular region or country.

FIG. 1 provides a flow diagram illustrating the steps of a method according to the present disclosure, more specifically, a flow-diagram illustration of steps for deriving crop yield and economic risk profiles. At step 100b the yield weather sensitivity to weather indices (such as an observed temperature variability and precipitation variability) is simulated under different technological scenarios. The weather indices are used as proxies of physical crop response to weather variability.

In an example, weather indices are used as proxies of the physical crop response to precipitation variability and excess temperature exposure wherein observed historical daily data for weather and for soil may be used to simulate crop yields using mechanistic crop modelling. Furthermore, daily precipitation and temperature data are used to build pixel-level databases of precipitation or temperature variability indices, wherein each index captures exposure to deficit precipitation or excess temperature during different time intervals of crop growth.

At step 100a the large scale climate variability (such as the inter-annual climate variability) is modelled under different simulated climate change story lines and historical records. At step 110, the yield sensitivity simulation, and the large scale inter-annual climate variability are used to produce grid-to-province probability density functions (PDFs) of yield loss captured by weather indices, under the condition of large scale inter annual climate processes. At step 120, the grid-level crop yield loss PDFs, subject to several climate and technological scenarios, are used to derive province level risk profiles of production loss. At step 130, the physical loss risk profiles from step 120 are used as an exogenous input variable to derive distributions of province-level economic losses.

At step 140, an optimum mix of risk mitigation and transfer instruments, which are to be implemented at the provincial scale to minimize and mitigate the risk of weather and climate-driven losses, is determined by comparison of risk profiles in step 130 under different climate change story lines.

The approach can be further understood at a high level from FIG. 2. At step 200 an index database is built at a local level (also referred to as grid level, being a geographical area where weather conditions can be considered to be homogeneous). This is based on historical weather data and can include, for example precipitation levels historically for different periods. From this approach, crop yield functions can be computed at each grid node for each of, for example, with a deficit rain fall index and a heat wave index (or any single or combination of relevant weather indices). This permits, at step 210, building a non-linear crop yield prediction model for example using generalised additive mixed models as discussed in more detail below. From this the vulnerability of crop yield to a given weather hazard can be modelled as discussed in more detail below.

In order to permit scalability and aggregation, at step 220 an indicative weather index is selected from amongst all of the weather indices for each of respective potential hazards such as drought or flood. As discussed below, the index selection methodology is based on machine learning in one embodiment for example using random forest techniques.

Turning to FIGS. 3a and 3b, it can be seen that crop yield in the case of two scenarios, flood (FIG. 3a) and drought (FIG. 3b) can be modelled as a function of the selected index allowing, as discussed in more detail below, yield index-based predictive functions to be obtained for varying technological scenarios. Additionally the statistical modelling of indices distributions, as discussed in more detail below, allows factoring in low probability, high impact events and high probability, low impact events.

The building of relevant models and indicative weather indices permits crop yield prediction based on various potential future climate scenarios. Yet further, the use of a single weather index per hazard per grid node allows aggregation of the result across a region comprising multiple grid nodes which is more accurate than selecting a single weather index for an entire region. Hence, at step 230 future weather index distribution is predicted using, for example, a mixed univariate probability distribution model fitting both central tendencies and extreme values to determine the projected probability distribution of indices such as deficit precipitation and heat wave indices. As discussed above, this therefore permits, at the grid level, identification of crop yield for respective scenarios for each grid node. Projection into respective scenarios is facilitated by linking the weather indices to large scale, low frequency variability climate drivers using a Hidden Markov Model-based techniques (or Linear Dynamical System-based techniques). Hence the climate change scenarios can be applied at grid level to the respective weather indices to provide a prediction of crop yield and the respective scenarios.

Finally, the results are aggregated at the regional level to provide a regional risk profile of crop production.

In an aspect of the present disclosure, the distribution of the yield is derived from probability distribution of each grid's weather index and the yield achieved for each value of the index distribution. In a further aspect, the distribution of production (i.e. yield multiplied by area) is obtained from the probability distribution of yield and the area planted in the pixel. In a further aspect, the method of the present disclosure derives from the distribution of production, the production level at different return periods levels driven by the weather hazards captured by the indices (e.g. production for the 1 in 5, 1 in 10, 1 in 15, . . . , 1 in 100 years events). In yet a further aspect, the distribution of production is obtained for each pixel and the method of the present disclosure aggregates a sum of each pixel's 1 in 5, 1 in 10, 1 in 15, . . . , 1 in 100 years production in order to obtain the regional risk profile of weather driven crop production under a given climate and technological scenario.

An outcome of the approach can be understood with reference to FIG. 4. As will be seen a plurality of grid nodes are shown at the location shown as plane 400, defined by longitudinal and latitudinal coordinates. For each grid location, N weather indices act as possible proxies of weather driven physical loss as shown at 402. Using the techniques discussed herein the most effective or representative weather indices for, or various, weather weather hazard are then selected for each grid location. These are shown at 404. Multiple climate scenarios can then be taken into account in the model by assessing their effect on the relevant weather index. As can be seen in FIG. 4, first and second climate change scenarios 406, 408 are shown.

More specific examples of the approach described will now be provided with reference to real-world scenarios.

In order to assess the weather-driven risk of production loss in the rural sector at regional and national levels, the response of key staple crops to specific weather hazards is modelled. In an embodiment, the aim is to assess the provincial-level risk exposure of (i) maize production to drought and heat wave hazards in the North-East provinces of Shandong and Hebei and (ii) rice production to heat wave hazard in the South provinces of Guangdong and Guangxi. To achieve this, weather indices acting as proxies of deficit rainfall and excess temperature-driven physical crop loss are used. A production vulnerability approach is then used, based on the building of a stochastic model explaining yield variability as a function of the weather indices variation. In order to apply this approach at provincial-scale, simulated crop yield and Generalized Additive Models (GAM) are used as a statistical framework modelling the synthetic yield response to weather indices' variability. Since the dynamic nature of the crop growth process and the specificity of its weather hazards response depend on the complex interaction of local environmental conditions (e.g. topography, insolation, mean local temperature, soil type etc.) this means that effective weather indices used to model the local crop's yield response have to reflect these specificities. In order to build and select effective grid level weather indices a variable selection recursive partitioning-based method is applied.

In one embodiment, mechanistic crop model-based simulations are adopted to enable estimation of different features of the crop development cycles such as final grain yield as these allow simulation of the impacts of individual or various factors on crop development. These models are mainly designed to perform plot-scale crop growth simulations with input parameters reflecting local physical, environmental and crop variety variability. In the specific embodiment the decision support system for agrotechnology transfer crop environment resource synthesis (DSSAT CERES) model is used. Such a DSSAT CERES model, is described in ‘J. W. Jones, G. Hoogenboom, C. H. Porter, K. J. Boote, W. D. Batchelor, L. A. Hunt, P. W. Wilkens, U. Singh, A. J. Gijsman, and J. T. Ritchie. The dssat cropping system model. European Journal of Agronomy, 18:235_265, 2003’. As regional-level crop simulations are used to assess the impact of weather variability and extreme weather events at relevant spatial scales for policy making, a regional crop model cross calibration-modelling approach is therefore used, for example to assess the impacts of precipitation variability and excess temperature exposure on different crops varieties and under different management scenarios.

Synthetic yield simulations were carried out at 0.5°×0.5° longitude/latitude resolution using different set of data to calibrate the mechanistic crop model.

In order to isolate the separate impacts of rainfall and temperature variability on yield variability, different experiments were carried out consisting of computing yield simulation at each grid node using 1961-2007 daily weather data series, keeping all weather variables but daily precipitation or maximum temperature fixed their daily average (1961-1990) climatological values. For instance, in order to simulate precipitation-driven yield time series, after calibration, DSSAT was run using sets of “fixed” daily weather variables [Tmax, Tmin, Radiation, Wind Speed]1961 1990 and a data set of daily precipitation data for the 1961-2007 period. Hence, 47-year yield series were obtained for each grid point. In this research work, individual impacts of precipitation and maximum temperature variation on crop production were assessed using this methodology. Although radiation dimming has been shown to also been a significant maize yield determinant in the North China plain, for simplicity and for the purpose of methodological demonstration only the two latter weather variables (i.e. precipitation and maximum temperature) were tested.

In order to compute expected physical loss based on weather indices univariate or multivariate probability distributions, the vulnerability functions of the studied system (i.e. the crop) to the considered weather hazards (i.e. drought and heat wave) need to be determined. The latter is carried out for each grid in the studied areas determining the response function of physical loss to variations in the weather indices values. In order to determine these response functions, the statistical framework of Generalized Additive Mixed Models is used. This flexible framework enables modelling of non-linear response functions such as those of complex bio-physical systems, for instance of a crop to various weather hazards. The basic framework of Generalized Linear Models (GLMs) is first outlined before introducing the GAMs framework used in the present research work are described in ‘J. Nelder and R. W. M. Wedderburn. Generalized linear models. Journal of the Royal Statistical Society, Series A, 135:370_384, 1972’ and ‘T. Hastie and R. Tibshirani. Generalized additive models (with discussion). Statistical Science, 1:297_318, 1986’, respectively.

### Deficit Rainfall and Heat-Wave Driven Yield Loss Functions of the Main Cereal Staple Crops

### Model Structure

In order to capture rice yield variation in response to excess temperature stress (i.e. heat waves) a Generalized Additive Model is built. Cubic regression spline functions are used as smoothing functions to achieve the latter. The heat wave-driven yield response model is characterized by the following structure:

g(μᵢ)=Xᵢθ+f₁(x₁ᵢ)+f₁(x₂ᵢ)+ . . .

Where, as outlined above, μi=E(Yi) with Yi the rice yield response variable following an exponential family probability distribution function with and yᵢ is an observation of the rice yield variable, Xᵢ is the i^{th} row of the model matrix with its corresponding θ parameter vector. Also, in order to model the univariate model of rice yield response to heat waves, a smoothing basis composed of natural cubic splines is used. As mentioned above, cubic regression splines are composed of sections of cubic polynomial functions for each [xi; xi+1] interval and “stitched” together at specific knot locations. In the present application, cubic spline smoothers are parametrized by optimizing the values at the knots of the function. The advantages of using natural regression splines as a smoothing function basis is the direct interpretability of its parameters, as well as not needing to re-scale the predictor variable prior to model fitting. The knots locations have nevertheless to be defined.

### Empirical Results

FIG. 5 displays several types of maize yield responses to the combined effects of heat wave and deficit precipitation in different pixels in Shandong and Hebei provinces as well as plots of rice yield responses to heat wave in different locations of Guangxi and Guangdong provinces. These illustrative graphs show the diversity of responses of rainfed maize to the combined effects of excess temperature and deficit precipitation stresses and the different features of irrigated rice yield responses to excess temperature stress depending on the different locations. This reflects the spatially heterogeneous responses of crops to weather variability. In effect, the responses of crops to environmental stresses depend on local environmental conditions such as soil type and topography. The next section presents the methodology developed to capture this crop/environment-specific response using weather indices.

### Index-Based Vulnerability Assessment of Extreme Temperature and Rainfall Variability

The methodology above is used to assess maize and rice yield responses to weather variability. Using a mechanistic crop model, synthetic regional-level yield data was obtained for the studied provinces of Hebei and Shandong in North East China and Guangxi and Guangdong in South China. Given the specific responses of maize and rice yields to weather variability depending on local environmental conditions, the assessment of the province-level risk profiles corresponding to different weather hazards needs to be carried out based on a robust assessment of local-level yield responses to weather variability. This section presents the weather index and machine learning-based methodology developed to assess local-to-regional responses of the studied crops to precipitation variability and excess temperature. The use of weather indices is presented before introducing the machine learning-based methodology applied to capture environment-specific crop responses to weather variability.

### Weather Indices Crafting

### Deficit Precipitation Index

The precipitation index structuring is presented below. It will be appreciated that whilst the precipitation index structuring described below is one way of structuring weather indices, there are many other possible ways of structuring weather indices and the model of the present disclosure is not limited to any one of these.

### Index Structure

A deficit precipitation index, i, is crafted in order to quantify the deficit precipitation below a set cumulative precipitation threshold during a time window, D.

The time window is defined according to the timing of the critical phenological phases of the crop system. Within this period, daily precipitation, r_{d} with d in [|1;365|], is accumulated for each of the 50 years of observed data. In each grid box the maximum historical cumulative precipitation in 50 years, CPₘₐₓ, value is extracted.

The deficit precipitation index is defined as the difference of the computed cumulative precipitation from its maximum historical value. For any given year, d in [|1;50|], the deficit precipitation index is defined as:

$$ly = {CP}_{max} - CPy$$

$$Where$$

$$CP ( y ) = {\sum }_{d in D} r ( d )$$

### Probability Distribution Truncation

Given the structure of the deficit precipitation described above, the right tail of the mixed probability distribution is truncated above DPₘₐₓ. With f*₁(i) the truncated mixed probability distribution, f₁(i) the initial mixed PDF and i the deficit precipitation index, we have:

$${f}_{I}^{*} ( i ) = \{ \begin{matrix}0 if i > {DP}_{max} \\ {kf}_{I} ( i ) if i ≦ {DP}_{max}\end{matrix} \\ Where k = 1 / ( 1 - p ) with \text{:} \\ p = {\int }_{{DP}_{max}}^{+ ∞} {f}_{I} ( i ) d i$$

### Heat Wave Index

All three studied staple crops are vulnerable to excess temperature stress during specific periods of their phenological development. In particular, the flowering phase physiological processes are most vulnerable to excess temperature stresses.

### Index Structure

In any given year y, the ‘heat wave index HI_{y} is crafted in order to determine the number of consecutive days within a set time window, D, where daily maximum temperature, Tₘₐₓ with d in[|1,365|], is above a critical temperature T_{c}, for n consecutive days or more.

$${HI}_{y} = {\sum }_{k} {\sum }_{t} {\{ {h}_{t} + {h}_{t , cons} \}}_{k} for \{ \begin{matrix}t ≧ n \\ t ∈ n\end{matrix} \\ Where \text{:} \\ {h}_{t} = \{ \begin{matrix}1 \vert if ∀ d ∈ [ \vert t - n - 1 , t \vert ] , {T}_{max , d} ≧ {T}_{c} \\ 0 if ∀ d ∈ [ \vert t - n - 1 , t \vert ] , {T}_{max , d} < {T}_{c}\end{matrix}$$

And {hₜ+h_{t,cons}}ₖ is a cluster of consecutive days where T_{max,d}≧T_{c} such that:

$${\{ {h}_{t} + {h}_{t , cons} \}}_{k} = \{ \begin{matrix}1 + {h}_{t , cons} if {h}_{t , cons} ≧ n - 1 \\ 0 if {h}_{t , cons} < n - 1\end{matrix} , k ∈ [ \vert I , int ( D / n ) \vert ]$$

This can be graphically illustrated as illustrated in FIG. 6, where coloured boxes define days with T_{max,d}≧T, and we set D=16, n=3 and HI_{y}=4:

### Probability Distribution Truncation

Given the structure of the heat wave described above, the right tail of the mixed probability f_{HI}(hi) distribution is truncated in order to fit a distribution, f_{HI}*(hi), up to the maximum possible value, HIₘₐₓ=D−1, attainable by the index, as follows:

$${f}_{I}^{*} ( i ) = \{ \begin{matrix}0 if hi > {HI}_{max} \\ {kf}_{HI} ( hi ) if ≦ {HI}_{max}\end{matrix} \\ Where k = 1 ( 1 - p ) with \text{:} \\ p = {\int }_{{HI}_{max}}^{+ ∞} {f}_{HI} ( hi ) d hi$$

### Weather Indices Stochastic Selection

Based on observed weather variables and modelled crop yields, several weather indices are modelled in order to act as proxies for drivers of yield variation. In the present case, given the mechanisms involved in the physiological development of crops, two weather variables—temperature and soil moisture—stand out as the main environmental drivers of non-irrigated cereal crop growth and, ultimately, yield quantity and quality.

Based on daily observed precipitation and temperature (minimum, average and maximum), several weather indices are modelled. One temperature-based index and one rainfall-based index are selected on the base of their respected predictive power of modelled yield. Hence the selected weather indices can be seen as yield proxies.

The indices selection methodology is based on the known Machine Learning technique of Random Forest classification. This methodology is based on the use of tree-based data clustering techniques using Classification and Regression Trees (CART) technique. We first present the general CART technique before introducing the Random Forest machine learning technique used in the present research.

### Recursive Data Partitioning and Random Forest-Based Variable Selection

General methods of recursive data partitioning and random forest-based variable selection are described in ‘L. Breiman. Random forests. Machine Learning, 45:5-32, 2001’. The recursive data partitioning and random forest-based variable methods used in the present disclosure are an adaptation of these methods described in ‘L. Breiman. Random forests. Machine Learning, 45:5-32, 2001’.

### Recursive Partitioning

A variable selection methodology in accordance with the method of the present disclosure is based on a non-parametric regression approach known as recursive partitioning. Recursive partitioning is used to construct classification and regression trees (defined below) where groups of response parameters are successively separated based on their similar response values. Contrary to linear regression models, non-parametric recursive tree partitioning allows extraction of non-linear interactions and high order interactions.

The successive splitting of a group of response variables is generally carried out by means of impurity reduction—where impurity refers to a measure of variable response similarity. Minimum impurity or entropy in a data set group is achieved where the relative frequency of one of the response class is zero while maximum impurity is attained when there is the same relative frequency for the two response classes. Hence in each node tree construction, the first split carried out is the one generating the highest impurity reduction where the variable selected (i.e. weather index) for splitting is the most strongly associated with the response variable (i.e. crop yield). Two methods of impurity measure are applied for split selection: 1) entropy measures such as Gini Index or Shannon entropy p-values of association tests with the response variable. Hence each successive node is split where the highest entropy level is detected or lowest p-value determined. The latter splitting method is used in the algorithm used in the present study.

Recursive partitioning is confronted with pitfalls of over-fitting when trees are gown deeply and random variation is also captured. This issue, shared with parametric regression, is nevertheless not discussed here as it does not influence Random Forest based variable selection.

### Ensemble Recursive Partitioning and Random Forests

The main limitation of recursive variable partitioning is the instability of tree-to-tree structure. This pitfall was solved by constructing an ensemble tree predictor where an ensemble of trees is averaged. Random Forest belongs to the technique of ensemble recursive partitioning method.

The Random Forest (RF) data clustering is based on adding a step of randomization after bagging to then develop a classification and regression tree (CART) ensemble. We will first present the bagging technique in order to analyze the strengths of the use of a RF-based methodology for variable selection.

### Random Forest Clustering and Application to Variable Selection

This sub-section presents the Random Forest-based methodology applied in this research to select the most effective grid-level weather indices for capturing the yield variability of the studied crops driven by excess temperature and precipitation variability. The use and application of a non-parametric Random Forest-based technique for variable selection is first discussed before presenting the methodology used in this research.

Such Random Forest-based methodology is described in ‘M. R. Segal, J. D. Barbour, and R. M. Grant. Relating hiv-1 sequence variation to replication capacity via trees and forests. Statistical Applications in Genetics and Molecular Biology, 3:Article 2, 2004’

### Recursive Partitioning and Variable Importance Assessment

Recursive partitioning RF-based techniques are applied in different fields confronted with the issue of selecting important variables within a high number a variables. RF-based predictor variable selection is, for instance, used in genetics where a high number of genes can be involved in the expression of a pathology but a specific gene needs to be identified to be targeted in the drug molecule design phase.

The selection of variables through random forests is achieved by computing a variable importance measure that quantifies the predictivness of the different variables from an initial sample.

### Variable Importance Measure

Two variable importance measures are used to assess the predictiveness power of a variable: 1) “splitting improvement” and 2) “permutation accuracy importance”. Splitting improvement is a measure that sums up the total average impurity reduction measured, for instance, by a Gini index gain, that a variable achieves in all of its positions in the forest. This variable importance measure is not used in the present study due to its potential bias and therefore not detailed here.

Permutation accuracy is measured and computed as follows. For each tree, Out-of-Bag (OOB) data is run down each tree making a random left-right split assignment when reaching a node splitting at a variable whose importance is being assessment. The OOB ensemble is computed. If V is an important variable, the distance of the terminal node for the data point from the original terminal node assignment position increases.

Such variable importance measure methods are described in ‘C. Strobl, A. L. Boulesteix, and T. Augustin. Unbiased split selection for classi_cation trees based on the gini index. Computationa Statistics and Data Analysis, 52:483-501, 2007’

### Random Forest-Based Variable Selection Strengths

CART-based variable selection has been shown to be biased in favour of variables presenting certain characteristics such as having various missing values. This bias is propagated in an ensemble of trees and is reflected in variable importance measures—in particular when predictor variables are of different types. Furthermore RF data selection is characterized by another induced artefact of favouring correlated variables over non-correlated ones. This latter bias is also reflected in permutation importance measures.

### Random Forest-Based Unbiased Variable Selection Applied

Unbiased variable selection can be implemented when node splitting subsamples are drawn without replacement, unlike in bootstrapping used in RF, together with the unbiased splitting at each node. This procedure allows the permutation variable importance measure to be interpreted robustly for variable selection.

### Random Forest-Based Weather Index Selection

### Indices Sample Computation

In order to select the weather index with highest yield variation explanatory power, the above outlined RF-based variable selection methodology is applied with a sample of 25 precipitation or 50 heat wave indices computed for each grid box. The sample of indices is computed in order to cover different possible time windows within the whole risk exposure time window. For instance, in the case of a maize crop with a growing period of 13.5 dekads (i.e. 135 days), a given heat wave or deficit rainfall value is computed for each day of the growing season as detailed in the previous sub-section. In a second step, weather indices are crafted by adding these daily values over different windows of time within the growing season period. The different cumulative periods are presented in FIG. 7 in the case of deficit rainfall indices. Cumulative heat wave indices are built using the same time-structure as deficit precipitation ones. 25 indices are built using 30 Celsius Degrees as a critical temperature while 25 other indices are built using 35 Celsius as the critical temperature.

### Index Selection

RF-based weather indices selection was carried for each grid box in the four studied provinces of Hebei and Shandong in North East China and Guangdong and Guangxi in South China. Given that South China provinces was used as a case study involving irrigated rice, only heat wave indices were selected. FIG. 8 displays the variable importance of precipitation indices in four contiguous grid boxes in Shandong province using maize yield as response variable.

### Indices Selection Results

### Shandong

### Precipitation Deficit Index

The selection results for maize deficit precipitation indices are presented in FIG. 9 for the three studied “technological adaptation” scenarios in Shandong. All twenty five possible deficit precipitation indices were selected as proxies of yield loss in the “local cultivar” and “irrigation scenario” while only nine were necessary in the “cultivar switch” scenario.

The comparison between the three scenarios reveals that the spatial structure of selected deficit precipitation indices' temporal aggregation is similar for the “local cultivar” and “irrigation” cases while a different structure is revealed under the “cultivar switch” scenario.

The unaltered “local cultural” scenario shows that, in Shandong's central mountainous area, maize yield response to precipitation deficit is best captured by an index “positioned” at the middle of the crop's phenological development period. The Western most area of Shandong is dominated by a late season deficit precipitation dominant crop response (i.e. during grain filling and maturing). Maize's response to deficit rainfall is meanwhile dominant during the first 40 days of the 135 growing period in the South of Shandong Province under the “local cultivar” scenario. The North West plains of Shandong Province show that the dominant index-based response of maize to deficit rainfall ranges from very early season (i.e. crop emergence during the first 30 days growing period) to mid-stage development (i.e. from green/yellow to red according the colour code presented on FIG. 9). The Eastern Shandong peninsula located between the Bohai and Yellow Seas has a heterogeneous index spatial structure ranging from early to middle and late season deficit rainfall indices. The latter can be explained by the equally heterogeneous topography of the area dominated by hills of up to 500 m of elevation.

The spatial structure of the RF-selected deficit rainfall indices under the “irrigation scenario” is similar to the one under the “local cultivar” scenario. Several local differences are noticeable nevertheless. The mountainous central area of the province previously dominated by mid growing season precipitation index dominant response is under this scenario dominated by very early to mid-stage growing period (i.e. crop emergence) precipitation index response.

In contrast with these earlier scenarios, the “cultivar switch” scenario displays in a homogenous and distinct crop response spatial pattern. The province shows a dominant early (i.e. first 35 days) to very early (i.e. first 20 days) dominant maize response to precipitation indices. The East most peninsula of Shandong together with the central mountainous region of Shandong are characterized by very early deficit rainfall crop response.

### Heat Wave Index

The maize heat wave indices selection results are presented in FIG. 10 for the three studied “technological adaptation” scenarios. While FIG. 7 presents the indices' temporal aggregation period, FIG. 11 presents the critical temperature thresholds of each of the indices. Twenty three indices were selected as most effective proxies of heat wave-driven yield variation in Shandong province under the “local cultivar” scenario, and twenty one were selected under the “irrigation” scenario, while twenty five indices were necessary under the “cultivar switch” scenario.

The “local cultivar” scenario is characterized by a spatially heterogeneous precipitation indices pattern. The heat wave index recording heat wave exposure over the whole growing period appears be predominant in the Southern region of the Province bordering Jiangsu. In the Northern plains and mountainous central-West regions of the province, the main period of maize sensitivity to excess temperature stress ranges from mid to mid-to-end of growing period. In the Western region of the province bordering Henan and Hebei, the crop shows predominant heat wave-driven stress sensitivity during the beginning or start-to-mid of the growing season. The Eastern peninsular region of Shandong displays a mosaic pattern of RF-selected heat wave indices ranging from very early (i.e. first 20 days) to end (i.e. last 30 days) of growing season.

Under the “irrigation” scenario, the main features of the spatial pattern observed under the “local cultivar” scenario are preserved. In the Western region of the province, a more homogenous sensitivity to heat wave-driven stress is apparent during the first half of the growing period. Maize grown in the South-East region of the province appears to be sensitive to excess temperature stress throughout the whole season. The Central and Northern plains regions are dominated by very early (i.e. first 20 days) and mid-season (i.e. 40^{th} to 90^{th} day of growing period) heat wave indices. From West to East of the peninsular region, very early to and mid-to-end (i.e. 30^{th} to 135^{th} day) of season heat wave indices are dominant.

The “cultivar switch” scenario displays a distinct RF-selected heat wave indices spatial pattern. From South-East to the West of the Province, including the central mountainous region of Shandong, maize crop appears to present a predominant sensitivity to heat wave-driven stress at the beginning or first half of its growing period (i.e. crop emergence and vegetative stages). In the peninsular region of the province, maize sensitivity to excess temperature stress is best captured by indices measuring exposure throughout the whole season and second half of the growing period.

A common feature of the three scenarios' excess temperature stress RF-based indices selection is the predominance of 30 Celsius as a critical threshold temperature over 35 Celsius. However, in both “local cultivar” and “irrigation” scenarios, the 35 degrees critical temperature threshold is predominant in the West region of Shandong bordering Hebei province and in the “cultivar switch” scenario, the 35 degrees threshold is predominant in the Northern plains and present to a lesser extent in the West of the province.

Hence it will be seen that in order to study the risk exposure of the rural system to weather variability and climates changes, a Probabilistic Risk Assessment-based (PRA) approach is used in this research. This methodology is based on separate assessments of stochastic and epistemic risks relevant to the studied system and provides insight to the decision maker in a transparent and unbiased way.

In an exemplary embodiment, to study the physical-to-economic stochastic risk profiles of determined regions of China derived from their exposure to various weather variability-driven hazards a production vulnerability assessment approach is used. This approach rests on the determination of (i) the probability distribution of a variable, i.e. a proxy or key input, capturing the response of the studied system (i.e. staple crops) to the weather hazards and (ii) the vulnerability function of the system to the range of possible values of the latter variable. These two functions enable determination of the average expected losses due to single or multiple weather hazards as well as to the physical-to-economic loss risk profile in the regions concerned.

The determination of the vulnerability functions of the staple crops considered in this research (i.e. rice and maize) is carried out by using a crop modelling approach. Given the high spatial heterogeneity of weather variability, the use of statistical yield records was not carried out given their high spatial aggregation level. Given that two major sources of weather-driven crop yield loss are precipitation variability and excess temperature, a mechanistic crop modelling approach was adopted in this research. The modular structure of the DSSAT crop model used in this research allows inclusion of crop variety, environmental (e.g. weather, excess temperature, and soil parameters) and local management practices and leads to robust and realistic point-based synthetic maize and rice yield figures. The DSSAT model is however used in this research to assess rice and maize yield variations at regional level. Although experimental results show that grid and regional-level cross-calibrated model outputs tend to over-estimate locally recorded yields, year-to-year yield variations are accurately simulated. In order to provide insight into potential risk management strategies as well as to bracket and estimate the underlying epistemic uncertainty deriving from the use of different potential technologies, maize yield simulations under three “technological shift” scenarios were carried out for this research. Using these DSSAT model outputs, the responses of maize and rice yields to the individual or combined effects of precipitation variability and excess temperature exposure (captured by “weather indices”) were modelled using Generalized Additive Models.

After carrying out the mechanistic crop modelling-based study of the yield responses to heat wave and precipitation variability-driven at grid-level, the determination and selection of appropriate variables (i.e. “weather indices” used in GAM-based modeling) capturing these responses is necessary in order to determine grid-to-province levels stochastic risk profiles. Weather indices were therefore built to act as proxies of physical crop response to precipitation variability and excess temperature exposure. Crops can be modelled as dynamic biophysical systems developing under various environmental constraints. The features of the crop's response to weather variability are dependent on local environmental conditions. Given the highly heterogeneous spatial distribution of environmental variables (e.g. soil composition, topography), the nature of the studied crop's responses to similar weather variability can differ from grid to grid. In order to capture grid-level crop's response to precipitation variability and excess temperature exposure, several tens of weather indices capturing a wide range of possible dominant responses to these hazards (e.g. dominant response during early crop development, or dominant response during reproductive stage) were built for each grid box of the studied provinces. A machine learning recursive partitioning-based technique also known as Random Forest was then used to determine the weather index most effective at capturing a given response.

The experimental results obtained show that the features of the response of maize and rice to precipitation variability and excess temperature are spatially heterogeneous. The latter indicates the importance of careful consideration in the choice of indicators to study the impact of weather variability on complex dynamical systems such as crops. The use of single indicators over large areas is likely to lead to underestimation of the risk of physical to economic losses due to weather variability and climates changes. Hence multiple proxies or key inputs are thus in some cases used.

The methodological framework is next described to assess the two components of weather-driven risk. Firstly, the assessment of the stochastic risk component of “extreme” low probability, high impact weather variability-driven physical losses is presented. Then, the assessment of the epistemic risk component of weather-driven risk derived from the multiplicity of possible future states of the climate system is tackled. The latter draws upon a prior understanding of the major drivers of the regional climates of South and North-East China and the Asian Summer Monsoon and is carried out through a “weather-within-climate” modeling approach, to permit improved performance deviation from the model.

As discussed above, deficit rainfall and excess temperature events are the two principal weather stresses endured by annual rain-fed crops systems. Here we present the stochastic modelling of the combined occurrences of deficit rainfall and excess temperature events. The mixed univariate (i.e. a separate statistical characterization of temperature and precipitation variables) probability distribution model using both Central Limit and Extreme Value Theory (EVT) (an example of such an Extreme Value Theory is described in ‘T. Lux and D. Sornette. On rational bubbles and fat tails. Journal of Money, Credit and Banking, 34:589_610, 2002’)-derived frameworks is presented before introducing the multivariate copula-based joint model.

### Mixed Univariate Probability Distribution Model

Optimum deficit precipitation and excess temperature weather indices were crafted above in order to act as proxies of crop productivity. The risk management oriented methodology of the present work requires not only assessing the probability of high impact, low probability events but also the variability of low and average values of weather indices in order to assess the full spectrum of yield loss probability. The approach that was adopted was to adopt a single probability distribution to simultaneously fit two asymptotic stochastic behaviours—central tendencies and extreme values—with two different probability distributions under a single probability density function. This was achieved by adopting and extending to the multivariate level the univariate model proposed in Vrac and Naveau (2007) [Vrac2007] that introduces a mixing function enabling the transition from central to extreme probability distribution functions as follows:

The above mixed Gamma-GPD model was used to determine the full-range probability distribution of deficit precipitation and heat wave indices in two North and South China regions. This model is particularly appropriate in the context of this research for several reasons. Firstly, as mentioned above, this mixed model allows determination of the distribution of both low/average values of the studied weather indices as well as of their high/extreme values. Secondly, the GPD distribution reduces the waist of data by enabling the fitting of the distribution using above-threshold data. However, the determination of an optimum threshold to then to obtain GPD distribution parameters remains a challenging question. The transfer function used in the mixed pdf model allows a systematization of the setting of this threshold in each of the over 1,230 grid boxes to which the distribution is fit.

An example of mixed univariate probability distribution models is described in ‘A. Sklar. (1959). fonctions de repartition a n dimensions et leurs marges. Publications de l'Institut de Statistique de l'Universite de Paris, 8:229-231, 1959’.

### Multivariate Modelling and Copula Decomposition

A multivariate stochastic modelling framework is necessary to understand the interaction and dependence of multiple variables. An example of this is described in ‘A. Sklar. (1959). fonctions de repartition a n dimensions et leurs marges. Publications de l'Institut de Statistique de l'Universite de Paris, 8:229-231, 1959’. In the present case, crops present both vulnerability to deficit rainfall and excess temperature driven stresses that produce yield losses. However, the vulnerabilities to environmental weather driven stresses of the various complex mechanisms of physiological crop development processes are not linear, for example, the non-linearity of the combination of drought and excess temperature stresses on crop yields. It is thus essential to understand the joint multivariate behavior of both drought and excess temperature weather indices in order to subsequently determine probabilistic production loss scenarios. In particular, the stochastic dependence of weather variables' extremes has to be accurately determined. An example of this is described in ‘P. Lambert, A. C. Cebrian, and M. Denuit. Generalized pareto t to the society of actuaries' large claims database. North American Actuarial Journal, 7:1-23, 2003’. The tail dependence characterization in the bivariate context is first presented before introducing the copula-based multivariate framework used in this research. An example of such a copula-based multivariate framework is described in ‘P. Embrechts, A. McNeil, and D. Straumann. Risk Management: Value at Risk and Beyond, chapter Correlation and dependence in risk management: properties and pitfalls, pages 176_223. Cambridge University Press, Cambridge, 2002’.

### Tail Dependence

The development of risk management instruments requires an accurate and robust prediction of the conjunction of rare and height impact events. For instance, in the present study, the objective of the extreme events scenarios model is to characterize and quantify the probability of a joint events of “extreme drought” and “extreme heat wave” occurring simultaneously. This is achieved by determining the tail dependence function of the bivariate probability distribution of a “drought” X and “heat wave” Y variables with a joint probability distribution function F as follows:

$$P ( Y < y , X > x ) = \frac{P ( Y > y , X > x )}{P ( X > x )}$$

Introducing the uniform transforms of both marginal functions Fₓ and F_{y} replacing x and y by the quantile functions (F_{X})⁻¹(u) and (F_{Y})⁻¹(u) with (u,v) in [0,1]² we can define the tail dependence parameter χ(u,v) as:

χ(u,v)=P(Y>F_{Y}⁻¹(u)|X>F_{X}⁻¹(u))

χ(u,v)=P(V>v|U>u)

Where D:[0,1]→[0,1] is the Pickands dependence convex function verifying for z in [0,1]:

max(1−z,z)≦D(z)≦1)

D(z) determines the degree of upper tail dependence and takes values of 1 and max(1−z,z) for total independence and dependence between both marginals' upper tails, respectively.

### Extreme Value Copulas

Various applications in areas such as environmental risk or financial risk assessment justify the need to extend the concept of copula-based multivariate modelling to cases where low probability, high impact events are of significance such as in the present research. Such examples of this is are described in ‘G. Gudendorf and J. Segers. Copula Theory and Its Applications, chapter 6, pages 127-141. Springer Berlin/Heidelberg, 2010’ and ‘H. Joe. Multivariate extreme-value distributions with applications to environmental data. Canadian Journal of Statistics, 22:47-64, 1994’.

### Risk Measures for Decision Making

In a risk management perspective, as seen above, the copula-based multivariate modeling allows a flexible quantification of the dependency structure of two or more stochastic variables that can each follow different distributions. Several measures of risk useful in informing the decision making process can be derived from the joint probability of weather indices as well as from their marginal distributions. These measures can be expressed as probabilities of occurrence of given combinations of events or in terms of return periods. Return periods allow expression of a risk exposure by translating the probability level of occurrence of an event in terms of the time interval separating the re-occurrence between two events of equal given severity. Hence, the decision maker can, based on such information, take the appropriate steps to manage different layers of risk (e.g. events occurring one every twenty years or less, or events occurring one in every hundred years or more) in the ways most appropriate given existing constraints. An example of such risk measures can be found in ‘J. T. Shiau. Return period of bivariate distributed extreme hydrological events, Stochastic Environmental Research and Risk Assessment, 17: 42-57 (2003)’.

### Joint Probabilities

Based on the copula density function C(F_{X}(x),F_{Y}(y)) with F_{X}(x) and F_{Y}(y) the cumulative probability distributions of X and Y stochastic variables, several useful joint probabilities can be obtained.

### Summary and Conclusions

The statistical framework used to characterize the individual and joint stochastic behavior of pixel-level weather indices was presented in this sub-section. The Extreme Value Theory-based parametric modeling of exceedances was first presented before introducing the multivariate copula-based framework used to assess the stochastic dependency of weather indices. Non-parametric and semi-parametric techniques, although used in certain circumstances to model extreme events stochastic characteristics were not considered here. Finally, characteristic risk measures used to translate stochastic characteristics for decision-making purposes were presented. A mixed gamma-GPD univariate model was used to model individual indices distributions. This uni-variate mixed model was enclosed within an extreme-copula multivariate model to assess the stochastic dependency structure of multiple weather indices in each pixel.

### Empirical Data Description

In the previous two sub-sections, the concept of copula-based multivariate modelling and its flexibility for modelling EVT multivariate distributions were presented. We now present the application of extreme-copula computation to assessing risk exposure of a given economic system to combined extreme weather events impacts. The data sets used in this research are presented below. The next section describes the methodology developed in this research to link the stochastic characterization of grid box-level weather indices to large scale climatic drivers in order to project these distributions in future scenarios.

### Data Source

Daily weather data is necessary in order to model extreme events where the physical impact can vary within daily time steps. Secondly, the highest possible weather data spatial resolution is necessary in order to avoid excessive interpolation smoothing that could mask the occurrence of localized extreme weather events, in particular those derived from precipitation variability.

### Data Formatting

Daily precipitation, maximum, minimum and average temperatures (T_{max}, T_{min}, T_{average}) data observed in a 0.25° x 0.25° Longitude-Latitude grid, from the 1 Jan. 1961 to 31 Dec. 2010 for the two regions of interest (FIG. 12) were obtained from the CMA NCC in ASCII format. These correspond to 18,262 data (per grid node) matrices for each of the chosen Northern and Southern regions.

Subsequently daily precipitation, Tₘₐₓ, Tₘᵢₙ and T_{average} were reformatted into Network Common Data Form (NetCDF) shell format using a FORTRAN routine. The latter was carried out using an existing routine written at CMA and adapted to read the specific format of the original format.

### A Downscaling-Based Methodological Framework to Predict Surface Weather Extremes Under Different Climate Change Scenarios

In the previous section, the EVT-based theoretical framework used to characterize extreme stochastic processes was described. The use of a POT approach within a mixed Gamma-GPD was then justified to study the full univariate distribution of weather indices. The latter framework was extended to the multivariate level to study the interaction of deficit precipitation and excess temperature events using a copula-based modelling approach. In order to forecast the uni or multivariate probability distributions of extreme weather events, the sole use of historical records presents a limitation while the use of GCM-modelled temperature or precipitation data is fraught with important uncertainties. Here, the use of a statistical downscaling-based methodology to forecast the studied weather events distributions at different time scales is presented.

### The Issue of Downscaling

While General Circulation Models (GCMs) generate synthetic data of up to 100 km of grid size spatial resolution, the needs of impact studies at the river basin, agricultural production or city scale require higher spatial resolution. In the context of climate change impacts and risk assessment, downscaling is central. Statistical downscaling methods, by making the underlying assumption that the current relationship between large scale climate processes and local weather variation will remain the same in the future, permits generation of local scale weather variables time series data. However, previous validation of used Statistical Downscaling Models (SDMs) with past climate changes has to be carried out before validating future weather time series. There are three main categories of SDMs:
1. Regression based models relating large scale climatic variables to locally observed weather variables via parametric or semi-parametric methods (multiple regression, neural networks or logistic and quantile regressions or kriging).
2. Stochastic weather generator relating large scale climate variables to local scale variables using random picking from a probability distribution adapted to the used weather variable's data set.
3. Weather typing involving a data pre-processing step consisting of clustering of recurrent large scale or regional atmospheric patterns. Downscaling is then performed on the intermediate data sets of weather regimes.

In the context of the study of extreme events impact, two approaches of downscaling are used. The first consists in downscaling indices measuring extreme events such as dry spells or consecutive days with rain above a certain threshold before statistically downscaling. The second approach consists of extracting local extremes after applying a SDM. In both cases, in order to assess the probability of occurrence of extremes, global ensemble simulations are used to generate extremes indices forecasts which are compared to the model baseline climate.

Examples of SDM applications to assess local probability distributions of extremes include a combination of Gamma and Generalized Pareto distributions to downscale and characterize low, medium and high values of extreme precipitation. In order to determine “low” to “high” extreme values without setting arbitrary thresholds, the “k” climatic variable probability density “merging” model can be used.

Alternatively a linear regression relates large scale predictors such as Monsoonal indices to Weibull distribution parameters in order to downscale wind speed probability distributions extreme precipitation events can be represented as a non-stationary Poisson point process to develop Stochastic Weather Generator based downscaling. Nevertheless, the most robust downscaling methodology consists, following the model of global model ensemble modelling, is to use several SDMs in order to better bracket structural model uncertainty.

Finally, it is important to recognize that given the underlying objective of extreme events prediction and risk assessment, statistical downscaling is constrained by the scarcity of historical data and, in some cases, by its inability to forecast extremes not fitting historical records distributions.

A weather typing statistical downscaling model is built in this research. This model based on a Non-Homogenous Hidden Markov Model (NHMM) (such a NHMM model is described in ‘L. R. Rabiner. A tutorial on hidden Markov models and selected applications in speech recognition. Proceedings of the IEEE, 77:257-286, 1989’) and its application to Monsoon-driven weather index-based modeling. The HMM theoretical framework is first presented before introducing the NHMM parameters' numerical estimation methodology.

### Non-Homogenous Hidden Markov Model

A central assumption made in modelling a stochastic process with a Hidden Markov Model is the stationary nature. The time stationarity is embedded in the fixed state transitions probability matrix A. The observed process stochastic properties remained also unchanged. Nevertheless, stationarity is an exception among natural as well as socio-economic processes. In order for the HMM framework to model non-stationary processes, state transitions probabilities are modelled as dependent variables of time-dependant covariates. Such a time-dependent HMM is thus named Non-Homogenous Hidden Markov Model (NHMM) [Rabiner1989]. This framework, where the hidden states transition matrix is no longer fixed, provides a flexible framework to model time-evolving processes such as extreme weather events depending on low frequency climate variability or industrial activity dependent on time depended economic regime transitions, as described in ‘A. W. Robertson, V. Moron, and Y. Swarinoto. Seasonal predictability of daily rainfall statistics over indramayu district, indonesia. International Journal of Climatology, 29:1449-1462, 2009’.

The current section describes the formulation and numerical parameter estimation of NHMM before introducing its application in the current research work in the next section.

### Spatial AIC-Based Topology Selection

The AIC model selection criterion is used at individual grid level. Nevertheless, given the final objective of assessing the impact of extreme weather events by using non-stationary covariates within the NHMM, a global section criterion is applied. Given the additive nature of the log-likelihood and model used degrees of freedom, AIC values can be added for all grid points included within the different areas studied.

AIC selection model is described in ‘H. Aikake. A new look at the statistical model identi_cation. IEEE Transactions on Automatic Control, 19:716-723, 1974’.

### Hidden Markov Model-Based “Weather-within-Climate” Model for the Asian Monsoon

The previous section presented the numerical estimation ethology applied in this research to develop a weather-typing NHMM-based downscaling methodology linking weather indices to large scale, low frequency variability climate drivers. The use of the NHMM framework to project weather indices distributions based on observed or modelled large scale climatic predictors of the Asian Monsoon is now presented, the data sets used in this research are presented in the next sub-section before displaying experimental results obtained.

### Hidden Markov Model Application

Regional weather regime and large scale atmospheric modelling are carried out in order to stochastically link the probabilistic occurrence of surface precipitation, or temperature extreme events, to conditional probabilities of different regional to continental scale weather regimes or large scale low frequency oscillations (FIG. 14). A coupled “weather-within-climate” model is developed in order to derive project historial local-to-regional weather indices uni and multivariate distributions into future global warming scenarios. Previous applications of NHMM-based modelling for climate downscaling have been applied for prediction of daily and seasonal precipitation to relate storm duration to synoptic scale climate drivers. The choice of North and South China climatic regions is aimed at assessing the pertinence or feasibility of using states transitions of weather regional index-based patterns conditional on large scale climatic predictors for applications in risk mitigation tools such as early warning systems.

Regional weather regimes are modelled via a first order Markov chain framework. Markov chain states are modelled using gridded daily rainfall and maximum temperature data sets. The P(R_{t}|S_{t}) conditional probability allows derivation of a Homogenous Hidden Markov Model (HMM). The HMM permits determination of the probability of occurrence of given extreme “weather-indices” conditional upon the different weather-regime states' persistence periods.

The integration of large scale oscillation indexes within the HMM framework allows introduction of non-homogeneity within the modelling framework and hence introduces predictor variables of different climate change story lines. Large scale climatic predictors were used as time-varying covariates in order to project states transition matrices (i.e. for each grid box) in different future scenarios via a Non-Homogenous Hidden Markov Model (NHMM). The latter indices were selected following discussions with expert modellers at the CMA.

### Empirical Results and Discussion

### NHMM Topology Selection

Following the global AIC-based (Aikake Information Criteria) topology selection method a two state NHMM was systematically selected in North-East multivariate and South univariate NHMMs. The ‘global AIC’ criteria refers to the sum of the pixel-level AIC scores for province level province-level homogenous NHMM state levels. The provinces' pixels where fitted using one to five states and two state NHMM yielded the lowest ‘global AIC’ score.

The North-East representative weather regimes captured by each states can be described as “wet and cold” and “dry and warm”. Under a “wet and cold” weather indices “regime”, the probability of occurrence of a deficit precipitation and/or heat wave event is lower than under a “dry and warm” weather indices “regime”. The NHMM topology is represented in FIG. 15.

### NHMM States Transition Dynamic

The two states NHMM were fitted using NINO 3.4 Index time series May-June-July time series as covariate. NINO 3.4 index is the sea surface temperature (SST) anomaly averaged over the area.

The NHMM transition probabilities show in all grid boxes that the probability of occurrence of a “warm and dry” state in North-East China or a “warm” state in South China increases under strong Nino years. This is consistent with historical observations linking East Pacific anomalous high SST levels leading to regional and global ocean-atmosphere circulation changes leading to below average precipitation in East Asia.

### Observations “Viterbi-Weighted” Most Probable Hybrid Distribution

The Viterbi algorithm allows computation of the most probable NHMM state sequence. As explained previously, each NHMM state is associated with a characteristic observation probability parametric univariate or multivariate distribution function. In order to compute the most probable historical distribution function of a given weather index in each grid point, a convex linear combination—or weighted sum—of each states parametric probability distribution is carried out as follows:

g=ωᵥf₁+(1−ωᵥ)f₂

Where g is the Viterbi-weighted distribution function, f₁ and f₂ are, respectively, state 1 and state 2 characteristic distribution functions and wᵥ in [0,1] is the Viterbi weight defined as follows:

$${ω}_{v} = \frac{{n}_{{S}_{1}}}{{n}_{{S}_{1}} + {n}_{{S}_{2}}}$$

Where nₛ₁ and nₛ₂ are the number of occurrences of state 1 and state 2 in the time series of most probable state sequence generated with the Viterbi algorithm.

### Univariate Heat Wave Case

Univariate NHMMs were fitted using Random Forest-selected observed heat wave indices in the South China studied region of Guangdong and Guangxi. A mixed Gamma-GPD parametric distribution function was used to model the probability distribution of individual weather indices. The univariate “Viterbi weighting” computation is illustrated in FIG. 16 for a grid point in Guangdong province.

### Multivariate Heat Wave—Deficit Precipitation Case

In the North studied region of Hebei and Shandong provinces, multivariate NHMMs were fitted using observed heat wave and precipitation indices time series in each grid point. The marginal parametric distributions were obtained by fitting mixed Gamma-GPD distribution functions while the stochastic multivariate dependency structure was obtained by fitting Gumbel copula on the marginals of both indices. Subsequently, in order to obtain the “most probable” bi-variate heat wave—precipitation, as in the univariate case, a Viterbi-weighted convex linear combination of each state's Gumbel copula was computed.

### Summary and Conclusions

This sub-section presented the downscaling methodology developed in order to link univariate or bivariate model of heat wave and deficit precipitation indices. This downscaling model based on a Non-Homogenous Hidden Markov Model enables differentiation of the parametrization of mixed-probability distribution of weather indices based on the measure of predictors of large scale climatic drivers of regional and local weather variability. Here, this was illustrated by using an indicator of East Pacific's SST given the well established strong link between the inter-annual ENSO and Asian Monsoon strength. In order to determine a representative distribution of weather indices responding to historically recorded or predicted large scale climatic patterns, the weighted sum of the (univariate or multivariate) pdfs corresponding to each characteristic regional weather regime state is computed (i.e. representing a state of the Asian Monsoon in this research). This was carried out by computing the most probable sequence of climate states in a given period of years applying the Viterbi algorithm to the computed NHMM.

Having developed a “weather-within-climate” and weather index-based methodology, risk profiles can be calculated under different technological and climate state changes in turn permitting risk profiles linking extreme weather events and climate state changes to generate a “climate-to-economy” risk modelling framework.

In order to inform disaster prevention and mitigation policy, economic impact analysis should enable determination of the economic impacts of climate driven production losses at different spatial, temporal and economic aggregation levels: producer, agricultural sector, other national economic sectors and the national aggregated economy at provincial and national levels. The accurate quantitative assessment of the dynamics of economic losses following “shock events”, such as extreme climatic events, is necessary, for instance, for key national or local public authorities. An example in China is the Emergency Management Office (EMO) that informs and assists the State Council in designing emergency response plans, ensuring a coordination with other key ministries and agencies, including ex-ante and ex-post disaster response plans. In particular, detailed economic assessment of potential disaster driven losses are key for EMO's mission of national level emergency plans design. In addition for public driven, disaster risk management authorities, potential ex-ante and ex-post natural disasters economic assessment is also relevant for provincial, national and international insurance and re-insurance industry. In particular, detailed potential economic loss risk assessment is central for rating agencies which inform the insurance and re-insurance industry that set premium rates. The China Insurance Regulation Commission, directly under the State Council's authority, has the mandate and authority to set the premium rates in the national-closed insurance industry.

Among the different analysis frameworks used for the economic assessment of disasters (natural or not), Input-Output (TO) modelling has been most widely adopted since the early 1970s'. The IO framework's suitability for modelling natural disasters is twofold: 1) the ability of the IO framework to represent the economic sectors interdependencies at variable disaggregation levels allows modelling of both direct and indirect higher order impacts following physical assets destruction, and 2) the relative simplicity of the IO framework. For instance, IO modelling has been used for modelling transportation systems disruption, electricity network disruption, as well as “general generic disaster” disruption assessment models such as HAZUS. On the other hand, the IO framework simplifying assumptions such as production functions linearity, the non-response to price changes, the lack of material restriction on resources consumption and the rigid structure of input and import substitution constrain the accuracy of the IO modelling. Other modelling frameworks such as Computable General Equilibrium (CGE) allow accounting of input and import substitution or price change. Nevertheless, due to its optimizing assumption (unlikely in a disaster situation) and the long run simulation (5-10 years) focus of CGE modelling, it is widely considered to underestimate disasters' direct and indirect (“higher order”) impacts. Natural disasters impact IO-based economic disruption modelling research has lead to several adaptations in order to reflect the constraints posed by disasters' situations. In particular, IO framework adaptations to temporal, geographic and endogenous counter-reactions phenomena characteristics of natural disasters situations have been developed, as described in ‘A. Steenge and M. Bockarjova. Thinking about imbalances in post-catastrophe economies: An input-output based proposition. Economic Systems Research, 19:205-223, 2007’, and ‘Y. Okuyama. Economic modeling for disaster impact analysis: Past, present and future. Economic Systems Research, 19:115_124, 2007’, and ‘Y. Okuyama, G. Hewings, and M. Sonis. Understanding and Interpreting Economic Structure, chapter Economic impacts of an unscheduled, disruptive event: a Miyazawa multiplier analysis, pages 113_144. Springer, Berlin, 1999’.

In the wake of the above mentioned and in order to embed post-shock demand and production function function behaviour an IO framework allows for the imbalances in supply and demand following a catastrophic shock to be accounted.

Given this research focus on the analysis of extreme weather events' impacts on the rural and wider economic systems in China, specific economic modelling models taking into account the specific circumstances encountered in disruption situations will be developed and applied. Therefore ad-hoc IO modelling (which as mentioned above, has been widely and successfully used to assess economic disruption propagation within the economy subsequent to a shock in one or more sectors of the economic system) will be used in this thesis. Regional Input-Output tables built by the Chinese Academy of Mathematics will be used in order to determine province level impact and to evaluate their spatial and temporal propagation in the national economic system. Input-Output tables will be adapted to take into account adaptive behaviour within the economy as well as production capacity loss.

Drawing from the initial extreme events' indices and physical losses probability distribution, under different adaptation and climate change scenarios, the probability distribution of key economic losses and recovery indicators ranging from producers' revenues to rural, urban and national aggregated economic disruption will be obtained.

### Proposed IO-Based Regional Probabilistic Economic Disruption Modelling

### Economic Modelling Rational

Economic modelling is carried out in order to evaluate (i) the direct impacts of modelled weather events driven losses of key staple crops' yields and (ii) the direct and indirect impacts on the whole economic network and production factors (e.g. labour wages) at provincial scale. The provincial scale is chosen due to the application oriented focus of the research project aimed at evaluating the pertinence of different ex-post and ex-ante risk mitigation and adaptation policies: 1) insurance-reinsurance and 2) early warning systems. In order to analyze micro and macro direct and indirect economic impacts, the Input-Output (TO) framework appears most appropriate. Specific modifications of the IO framework adapted to economic model representations are carried out to adequately model supply-driven economic impacts.

### Supply-Push Model

The Gosh supply-push model structure implies the three hypothesis of 1) a planned economy, 2) severe excess demand, and 3) government imposed restrictions/control on supply. The Gosh model is defined as follows and such a model is described in ‘A. Ghosh. Input-output approach to an allocative system, Economica. 25, 58-64 (1958)’.

### Empirical Data Description and Augmenting

### IO Data Description

In collaboration with the Chinese Academy of Mathematics and Systems Sciences Centre for Forecasting Sciences, IO tables were obtained for the six North (Hebei, Shandong, Tianjin and Beijing) and South (Guangdong and Guangxi) focus provinces. The IO tables compiled every 5 year period in China by the China Statistical Bureau comprise:
47 economic sectors transaction table
4 “added value” sectors
7 consumption categories

Within official IO tables, staple grain crops productive sector is contained within an aggregate “Agriculture, forestry, animal husbandry and fishery” sector. Hence, in order to appropriately model direct and indirect cascading impacts on the economic network of the supply decline of grain crops due to extreme weather events, disaggregation of maize and rice from the above aggregate sector is necessary. Additional data needed to be collected for each studied province and staple crop in order to accordingly ‘augment’ the IO model was:
Provincial level inter-industry sales (output) and consumptions (input),
Provincial level disaggregated (private demand, exports, imports, etc.) demand figures
Provincial level disaggregated (labour costs or wages, value added tax, total production value)

The above data was obtained from 1) provincial Statistical Yearbooks of each province collected from China National Library, and 2) National Inter-industry Intermediate Goods Transactions Records retrieved at the China Statistical Bureau.

### IO Model ‘Augmenting’

In order to reliably model the continuum of physical and economic impacts of the probability distribution-based extreme weather events scenarios, the productive sector has to be distinguished in the studied economic system. The disaggregation of the two staple crops is necessary to enable funneling of the previously obtained probability loss functions directly into the economic network model. The ‘insertion’ of probabilistic physical production loss scenarios into a Gosh Supply-Push Regional IO-based model enables, keeping a constant market demand, assessment of the disaggregated and aggregated direct and indirect impacts on all actors of the economic network.

The bi-proportional matrix balancing technique (RAS) is used to augment the regional IO models.

### A Three Pillars Risk Management Policy Proposal: Mitigation, Transfer, and Forecast

### Risk Profile-Based Risk Management Policy Mix Tailoring

The results obtained in this thesis show that the risk profiles of physical and economic loss driven by extreme weather events under different climate states and technological scenarios vary considerably. Based on these results a three pillar-based risk management policy mix approach is proposed in order to generate an enabling environment to sustain economic growth and protect most vulnerable rural populations. The “three pillars” of the proposed policy mix can be defined as follows:
Risk mitigation: instruments enabling a decrease in vulnerability of a system to a given hazard. In the case of weather-driven crop production loss, risk mitigation measures range from technology-based instruments such as irrigation, water conservation techniques and use of improved crop varieties to management improvement strategies.
Risk transfer: instruments transferring a share of the risk burden to other economic agents in exchange for a payment. Such instruments can be used to optimize the management of residual risk which can not be cost-effectively managed with risk mitigation instruments. The primary insurance market markets risks with return periods exceeding 10 to 20 years return period while the re-insurance sector is better suited at transferring higher impact, lower probability risk (e.g. exceeding 100 to 250 years return periods risk).
Risk forecast: instruments based on the prediction of occurrence of a hazard enabling the implementation of damage reduction strategies. Early warning systems used in earthquake and tsunami damage prevention instruments are examples of the latter.

The development and implementation of each of these risk management instruments needs to be tailored according to the risk profiles characterizing a given region or country. In effect, given the region/country-level aggregate vulnerability response to different levels of a hazard considered, the investment in risk mitigation to increase physical resilience might be cost-effective only up to a certain level of risk. The use of risk transfer and risk forecast-based instruments provides strategies to efficiently manage the residual risk with the resources available in the region/country considered.

The following sub-section first presents the role and place of the impact of weather variability and climate changes studied in this thesis in sustaining a vicious circle of low and variable rural crop production and slow economic development before displaying the three pillar-based risk management enabling environment of a virtuous circle of food security and economic development.

### Enabling Environment, Virtuous Circle and Food Security

### Weather-Driven Growth and Food Security Impingement, and Poverty Vicious Cycle

The persistence of low and variable crop production in the rural sector is at the centre of a vicious circle of poverty, food insecurity and slow economic development. Amongst the several factors affecting yield levels and variability, weather variability and climate changes is prominent.

The variability of agricultural production and the lock-in of low production has a direct impact on the livelihoods of rural producers by curtailing available income. Similarly, production variability is directly translated in volatile crop commodity prices which affect directly rural and urban poor as well as further intensifying production variability as a feedback impact. The low incomes of rural producers further weakens the economy by decreasing the demand for non-agricultural goods and services. The unstable environment deriving from the latter attracts low levels of investment in better rural infrastructure and technology and further locks-in rural consumers into a low productivity crop productivity. In addition, the variable and cyclically unproductive rural sector driven by the impacts of weather variability and climate changes also enhances the persistence of a macro-economic environment unable to formulate and enact stable policies so dampening the development of the private sector and transport infrastructure. This further locks-in the region or country in a vicious circle of food insecurity and poverty.

This thesis presents a methodological approach to modelling the cascading climate-to-economy impacts derived by weather variability and climate state changes in the rural crop production sector and the rest of the economy. The probabilistic risk assessment-based methodology enables determination of probabilistic estimates of province-level risk profiles of direct and indirect economic losses caused by different weather hazards.

In order to break the vicious circle of food insecurity and in poverty driven by weather variability and climate state changes, this thesis suggests a regionally-tailored risk management strategy balancing three pillars of risk management policy mix. The following sub-section presents the rational of the proposed three pillar-based enabling environment based on the results of this research work.

### A Three Pillars-Based Weather and Climate Risk Management

As outlined in the previous sub-section, weather variability and climate changes have direct and indirect impacts on rural development and sustain the vicious circle of food insecurity. The experimental results of this thesis show that the province-level probabilistic risk profiles of direct and indirect economic impacts reveal significant sensitivity to the impacts to the extreme weather events and climate state changes.

The establishment of sustainable and continuous rural development rests on the development of a virtuous circle of agricultural development. However, as shown and quantified in this thesis, due to the important sensitivity of the rural activity to the impacts of extreme weather events and climate state changes, a comprehensive mix of risk management policies needs to be put in place in order to generate an enabling environment for sustaining the development of the virtuous circle of rural development. The enabling environment is embodied by the three pillars of risk mitigation, risk forecast and risk transfer as shown in FIG. 17.

The simulation of investment in physical resilience showed that irrigation-based risk mitigation can dampen the risk exposure of a province to the combined effects of heat waves and precipitation variability. Similarly, the investment in crop variety R&D can have, as seen in this thesis, significant impacts on modifying a province/country level risk profile. However, given the limited resources available for any relevant administrative unit and diminishing returns on investment on risk mitigating infrastructure, the cost-efficiency of such investments should be determined based on sound risk management objectives. For instance, while irrigation might appear economically sound in a high yielding area of Shandong province, the deployment of a fully fledged irrigation infrastructure in the mountainous low yielding central region of Shandong might be more questionable. The embedding of the price of water scarcity further diminishes the economic returns of such a risk mitigation strategy.

In order to minimize the cost for society, government and ultimately rural producers caused by the impacts of extreme weather events and climate state changes, the layering of different levels of risk should be carried out and managed using the three pillars of the virtuous circle. Beyond a level of non-economic efficiency, the use of financial preparedness instruments such as risk transfer permits efficient management of the residual low probability-high impact, risk exposure and minimizes costs to all stakeholders. Ultimately, as shown at the bottom of FIG. 17, the regional and risk profile-specific deployment of the three risk management pillars enables smoothing and minimization of the costs due the impacts of extreme weather events and climate state changes. The latter avoids deviating resources necessary for the medium and long term investments necessary for maintaining the virtuous circle of rural development and food security.

### Summary and Conclusions

Hence a methodological framework enabling determination of province-level direct and indirect economic loss risk profiles was presented first presented. The Input-Output model-based modeling of province-level economic losses was carried out based on the probabilistic risk profiles of provincial production loss driven by the combined or individual effects of precipitation variability and/or heat waves on maize in Shandong and Hebei and on rice in Guangdong and Guangxi. The “climate-to-economy” cascading methodology developed in this thesis permits explicit and direct integration of the weather variability and climate state changes-driven physical losses to their impact in the economic network via a supply-shock impact economic modeling. Unlike the model formulation of climate-driven economic impacts appraisal used in the major Integrated Assessment Models guided more by constraints of “mathematical convenience” the methodology proposed in this thesis allows rooting and constraining of economic impacts by the local and regional stochastic characteristics of weather variability and climate state changes and of the local response of the economic system considered (i.e. the crop production sector in this case) as well as by the technological risk mitigating scenario considered.

The results obtained show the important variations of province-level risk profiles depending on the regional features of weather and climate variability and technological scenarios. In the Northeastern provinces of Shandong and Hebei, the effect of low frequency climate state changes is masked by the important high frequency weather variability. The simulation of irrigation infrastructure across Shandong province appears to fully mitigate the combined low and high frequency impacts of precipitation variability and heat waves on maize production. In contrast, in South China's provinces of Guangdong and Guangxi, the effect of low frequency climate state changes masks the impact of high frequency weather variability on province-level heat wave-driven rice production.

The large direct and indirect economic impacts obtained for extreme weather events of short and long return periods reveal the fiscal and medium to long term public budgeting nature of the risk studied. In order to minimize and cap the cost of weather and climate impacts on the society, government and producers, several risk management instruments can be used. The investment in infrastructure that increases physical resilience was shown to be effective in mitigating risk. However, the economic efficiency of such investments decreases with the level of risk considered and is only justifiable up to a certain level of risk. In order to manage the residual risk, instruments of risk transfer and risk forecast can decrease ex-post event costs of damage. Given the conception of, and attitude to, risk prevalent in China as well as the possibility of diversifying province-level risk, the development of a province-level Cat-Bond-based risk transfer programme managed by the central government and buttressed on the risk financing capacity of the reinsurance and international capital markets would provide a framework to ensure financial preparedness to weather disasters in China. As shown in FIG. 17, a “three pillars”-based risk management enabling environment for rural development and food security is proposed.

It will be appreciated that whilst the modelling processes described above are presented in relation to weather and climate based considerations, they can be applied to any appropriate system. The approach can be implemented in any appropriate manner including hardware, firmware and software and on any appropriate machine, relying on any appropriate data source.

1. A computer implemented method of deriving performance from a local model having a plurality of model inputs, comprising identifying a key model input affecting model output for a predetermined model environment, obtaining a prediction of a future key model input value and inputting the future key model input value to the local model to derive predicted performance.

2. A method as claimed in claim 1 in which respective key model inputs are identified for a plurality of model environments.

3. A method as claimed in claim 1 in which future key model input values are predicted for one of a plurality of future scenarios.

4. A method as claimed in claim 1 in which a plurality of models are generated for respective localities and the future local model outputs are aggregated to provide an aggregated future predicted output.

5. A method as claimed in claim 1 in which the local model comprises a local crop yield prediction model.

6. A method as claimed in claim 5 in which the key model input comprises a weather index.

7. A model as claimed in claim 6 in which the weather index is derived using recursive partitioning.

8. A method as claimed in claim 5 in which the model environment comprises one of drought, flood and heat wave.

9. A method as claimed in claim 1 in which the future key model input value is predicted based on a predetermined climate change scenario.

10. A method as claimed in claim 9 in which the prediction is based on the method in Markov modelling.

11. A computer readable medium arranged to perform the method of claim 1.
